(19) United States
(12) Patent Application Publication
(10) Pub. No.: US 2007/0154609 A1
(43) Pub. Date: Jul. 5, 2007

(54) Extrudable Food Composition

(76) Inventors: Yin Li, Ballwin, MO (US); L. Mark Hanover, Mt. Zion, IL (US); Nancy Hanover, Mt. Zion, IL (US)

Correspondence Address: WILLIAMS, MORGAN & AMERSON, 10333 RICHMOND, SUITE 1100, HOUSTON, TX, 77042, US

(21) Appl. No.: 11/620,183

(22) Filed: Jan. 5, 2007

Related U.S. Application Data
(60) Provisional application No. 60/813,602, filed on Jan. 5, 2006.

(51) Int. Cl. A21D 10/00

(52) U.S. Cl. 426/549

(57) ABSTRACT

A process for making an extruded food product includes providing an extrudable food composition that comprises at least one of alkenylsuccinate starch and emulsifying protein. The extrudable food composition is extruded through a die to form an extruded food product. Optionally, the process can further comprise heating the extrudable food composition before and/or during the extrusion of the composition through the die, whereby the composition is at least partly cooked.

This application claims priority from U.S. provisional patent application Ser. No. 60/813,602, filed on Jan. 5, 2006, which is incorporated herein by reference.

### BACKGROUND OF THE INVENTION

A variety of food products are produced by extrusion. Examples of such food products include snack foods, breakfast cereals, confectionery, and pet foods. In an extrusion process, a food composition is formed into a flowable, semi-solid mass. This semi-solid mass is typically compressed and forced through a small aperture, known as a die, to form the food composition into a desired shape.

A typical extruder includes a screw, a feeder to meter in the raw ingredients, and a barrel that surrounds the screw. The screw conveys the composition towards the die. In many cases, heat can be applied to the food composition in the barrel and/or as it is extruded through the die. Depending on the temperature and pressure, the food composition can be entirely or partially cooked during extrusion. Alternatively, if relatively low temperature and pressure are used, the extrusion can be simply a non-cooking, forming process.

One problem that can occur in the extrusion of food compositions is die blockage, in which the food composition clogs in or around the die, thereby stopping the flow of the composition. In an effort to prevent this problem, emulsifiers such as lecithin and mono- and diglycerides have been added to food compositions to serve as extrusion aids. When such traditional emulsifiers are used, they typically lower shear and viscosity, reduce radial expansion, and increase longitudinal expansion. Vegetable oil is sometimes also used as a lubricant in the extrusion of food compositions to lower shear and viscosity. Additionally, rice bran extracts are sometimes used as an extrusion aid in an effort to reduce die blockage.

There is a need for new extrusion aids that can help prevent die blockage while maintaining and/or improving other properties of food compositions.

### SUMMARY OF THE INVENTION

One aspect of the present invention is a process for making an extruded food product. The process comprises providing an extrudable food composition that comprises at least one of alkenylsuccinate starch and emulsifying protein. The extrudable food composition is extruded through a die to form an extruded food product. Optionally, the process can further comprise heating the extrudable food composition before and/or during the extrusion of the composition through the die, whereby the composition is at least partly cooked.

In some embodiments of the process, the extrudable food composition comprises 0.01-25 wt % of alkenylsuccinate starch, emulsifying protein, or a combination of the two. In some embodiments, the extrudable food composition further comprises at least one whole grain flour, such as whole grain wheat flour or whole grain oat flour, or amylase-resistant starch.

Another aspect of the invention is an extrudable food composition. The composition, as described above, comprises at least one of alkenylsuccinate starch and emulsifying protein, and is capable of being extruded through a die to form an extruded food product.

### DESCRIPTION OF ILLUSTRATIVE EMBODIMENTS

One aspect of the present invention is a process for making an extruded food product. The process begins with an extrudable food composition that can comprise one or more ingredients that are suitable for consumption by humans or animals. Examples of suitable ingredients include, but are not limited to, starch, flour, meal, textured vegetable protein, fats, oils, flavorings, and preservatives. A wide variety of ingredients can be used, and such ingredients are well known in the food industry.

Starches and flours used in the composition can come from one or more of a variety of sources, such as corn, wheat, pea, potato, rice, tapioca, and others known in the industry. Waxy or high amylose varieties of corn can also be used. Chemically modified starches can be used, as well as amylase-resistant starches. It should be understood that a combination of two or more types of starch can be used.

In addition to the above-described ingredients, the extrudable food composition comprises either alkenylsuccinate starch, emulsifying protein, or a combination of the two. In some embodiments of the invention, the concentration of alkenylsuccinate starch, emulsifying protein, or a combination of the two, in the extrudable food composition is 0.01-25%. In certain embodiments, the concentration is 0.1-15%. (All percentages of food compositions in this patent are in weight percent unless otherwise stated.) In some embodiments of the invention, the alkenyl group of the alkenylsuccinate starch has from 2-12 carbon atoms. Octenylsuccinate starch is one suitable example. Such starches are commercially available, for example STA-CAP® 660 starch and MIRA-MIST® 662 starch, both available from Tate & Lyle (Decatur, Ill.). In some embodiments of the invention, alkenylsuccinate starch having a relatively high viscosity is preferred.

The emulsifying protein is one that has the capability to emulsify a quantity of oil. For example, in some embodiments of the invention, the emulsifying protein has a emulsifying capacity of at least about 400 g of oil per g of protein. In other embodiments, the emulsifying capacity of the emulsifying protein is at least about 600 g/g, or at least about 800 g/g. An assay for determining the emulsifying capacity of a protein is described in Example 6 below.

One suitable type of emulsifying protein is emulsifying wheat protein. Such emulsifying wheat proteins are commercially available, for example MERIPRO 707 and 711 starches, both available from Tate & Lyle. Other suitable emulsifying proteins include, but are not limited to soy protein, other vegetable-derived proteins, and caseinates.

The process of making the extruded food product also includes extruding the composition through a die to form an extruded food product. The presence of the alkenylsuccinate starch and/or emulsifying protein helps prevent die blockage, and in some embodiments of the invention can maintain or enhance other properties of the composition. Optionally, the extrusion process can include heating the extrudable food composition before and/or during the extrusion of the composition through the die, causing the composition to be entirely or partly cooked.

In one specific embodiment of the invention, the extrudable food composition comprises 0.1-15 wt % of octenylsuccinate starch and at least one of whole grain flour and amylase-resistant starch, and the composition is heated before and/or during the extrusion through the die, so that the composition is at least partly cooked.

After extrusion, the extruded food product can be dried and/or treated in other ways that are well known in the food industry.

The above-described process can be used to make a variety of extruded food products. Examples include, but are not limited to, snack foods, breakfast cereals, textured vegetable protein products, and pet foods.

The use of alkenylsuccinate starch and/or emulsifying protein in extrusion of food products can produce a number of benefits as compared to conventional extrusion aids, such as lower fat content, lower cost, more radial expansion (which results in lower density), more complete and/or faster cooking, better moisture and fat control, and better flavor, mouth feel, and color. The elimination of conventional extrusion aids, such as mono- and diglycerides, from the food composition, also results in a simpler or “cleaner” product label. Elimination of soy-based ingredients can also be a benefit in some applications.

The present invention can be especially useful in the preparation of food products that comprise whole grain flour, such as whole grain wheat flour or whole grain oat flour. In comparison to refined grain materials, whole grain ingredients are higher in protein, fiber, and fat, which are known to reduce expansion in extrusion and to tend to produce poor texture in food products. These problems can be reduced, at least in some instances, by the use of the present invention.

Specific embodiments of the invention can be understood further from the following examples.

### EXAMPLE 1

Three compositions were prepared which contained 99% corn meal (Bunge, CCM260) and 1% n-octenylsuccinated starch (either STA-CAP® 660 starch or MIRA-MIST® 662 starch, both from Tate & Lyle). For comparison, a composition was prepared that comprised 99.5% corn meal and 0.5% Nurice rice bran extract (RIBUS). Each of these four compositions was extruded in a Leistritz ZSE 18 horsepower extruder using a low shear screw profile. The conditions in the extruder, and the properties of the composition before and after extrusion, are given in Table 1.

TABLE 1

| | Sample | | | |
|---|---|---|---|---|
| | 1 | 2 | 3 | 4 |
| Extrusion aid | Nurice (0.5%) | MIRA-MIST 662 (1%) | STA-CAP 660 (1%) | STA-CAP 660 (1%) |
| Temperature profile (° C.) | | | | |
| Zone 1 | 20/29 | 20/29/28 | 20/28/28 | 20/28 |
| Zone 2 | 20/63 | 20/59/59 | 20/61/61 | 20/58 |
| Zone 3 | 20/100 | 20/101/101 | 20/101/101 | 20/101 |
| Zone 4 | 160/158 | 160/161/160 | 160/159/160 | 160/158 |
| Zone 5 | 175/174 | 175/175/175 | 175/175/174 | 175/174 |
| Zone 6 | 80/195 | 80/194/191 | 80/196/194 | 80/194 |
| Material moisture (%) | 10.4 | 10.4 | 10.4 | 10.4 |
| Feed rate (g/min) | 112.0 | 112.0 | 112.0 | 118.0 |
| Water rate (ml/min) | 8.9 | 8.9 | 8.9 | 8.9 |
| Screw speed (rpm) | 200 | 200 | 200 | 200 |
| Extrusion moisture (%) | 17.0 | 17.0 | 17.0 | 16.7 |
| Product temp. (° C.) | 159 | 159 | 160 | 160 |
| Die pressure (psi) | 1300 | 1378 | 1368 | 1399 |
| % torque | 38 | 40 | 39 | 41 |

The % torque is an indication of mechanical energy dissipation. When % torque is higher, product temperature is usually higher (i.e., more cooking occurs) at a constant rate and moisture. Die pressure can also increase when more cooking occurs. The data in Table 1 indicate that the compositions with octenylsuccinate (OS) starch exhibited higher % torque and die pressure than did the composition without OS starch. Samples 3 and 4, which used STA-CAP® 660 OS starch, also showed a higher product temperature.

Die blockage was eliminated or reduced in the compositions comprising OS starch.

### EXAMPLE 2

A food composition was prepared that contained the following ingredients:

| | |
|---|---|
| whole wheat flour | 35% |
| corn meal | 25% |
| amylase-resistant starch | 35% |
| MERIPRO 707 partially hydrolyzed wheat protein | 2% |
| WAXY NO. 1 food starch | 2% |
| STA-CAP ® 660 starch | 1% |

### EXAMPLE 3

A food composition was prepared that contained the following ingredients:

| | |
|---|---|
| corn meal | 52.5% |
| whole wheat flour | 20.0% |
| rice flour/rice meal | 15.0% |
| oat flour | 5.0% |
| MAXIMAIZE ® HV starch | 5.0% |
| salt | 1.5% |
| STA-CAP ® 660 starch | 1.0% |

(MAXIMAIZE® HV starch is a modified waxy starch available from Tate & Lyle that has a high viscosity profile in neutral to mildly acid pH foods.)

### EXAMPLE 4

A food composition was prepared that contained the following ingredients:

| | |
|---|---|
| corn meal | 49.88% |
| whole wheat flour | 20.0% |
| rice flour/rice meal | 15.0% |
| oat flour | 5.0% |
| MAXIMAIZE ® HV starch | 5.0% |
| salt | 1.5% |
| STA-CAP ® 660 starch | 1.0% |
| maltodextrin + sucralose | 0.625% |

### EXAMPLE 5

A food composition was prepared that contained the following ingredients:

| | |
|---|---|
| whole wheat flour | 70% |
| amylase-resistant starch | 25% |
| MERIPRO 707 partially hydrolyzed wheat protein | 5% |

The composition of Example 2 delivers an excellent source of fiber (5 g dietary fiber per 30 g serving); the composition of Example 3 is a multigrain formula that delivers a good source of fiber (3 g dietary fiber per 30 g serving); the composition of Example 4 is a multigrain formula sweetened with sucralose; and the composition of Example 5 is a wheat base formula that delivers an excellent source of fiber.

### EXAMPLE 6

The following procedure can be used to determine the quantity of oil that can be emulsified at standard conditions by a protein solution. Oil is added to a continuously stirred protein solution until the formed emulsion breaks. This break point can be detected audio-visually or with the aid of conductivity measurements. It is characterized by the transition of an oil/water emulsion (conducting) to a water/oil emulsion (non-conducting).

The reagents used include a soluble protein, such as a soluble wheat protein, 0.5N NaOH, 0.5N HCl, soy oil, and demineralized water.

1.5 g of the protein and 90 ml of demin. water are added to a 250 ml beaker, followed by stirring for 10 minutes with a magnetic stirrer. The pH is adjusted to 7 with NaOH or HCl, and the weight is adjusted up to 150 g with additional demin. water, resulting in a 1% protein solution. The mixture is placed under a stirrer, and stirring begins as oil is pumped into the beaker, at a rate of 45-50 g oil/min. The stirrer speed is accelerated to 6000 rpm during the first 30 seconds. The beaker is moved up and down in order to assure better mixing if necessary. For soluble wheat proteins, the breaking of the emulsion can be observed, and the use of conductivity measuring apparatus is generally not necessary.

The emulsifying capacity is expressed in terms of grams of oil that can be emulsified by one g of protein (g oil/1 g protein).

The preceding description is not intended to be an exhaustive list of every possible embodiment of the present invention. Persons skilled in the art will recognize that modifications could be made to the embodiments described above which would remain within the scope of the following claims.

What is claimed is:

1. A process for making an extruded food product, comprising:
providing an extrudable food composition that comprises at least one of alkenylsuccinate starch and emulsifying protein; and
extruding the composition through a die to form an extruded food product.

2. The process of claim 1, further comprising heating the extrudable food composition before and/or during the extrusion of the composition through the die, whereby the composition is at least partly cooked.

3. The process of claim 1, wherein the extrudable food composition comprises 0.01-25 wt % of alkenylsuccinate starch, emulsifying protein, or a combination of the two.

4. The process of claim 3, wherein the extrudable food composition comprises 0.1-15 wt % of alkenylsuccinate starch, emulsifying protein, or a combination of the two.

5. The process of claim 1, wherein the extrudable food composition comprises alkenylsuccinate starch, and wherein the alkenyl group has from 2-12 carbon atoms.

6. The process of claim 1, wherein the extrudable food composition comprises octenylsuccinate starch.

7. The process of claim 1, wherein the extrudable food composition comprises emulsifying wheat protein.

8. The process of claim 1, wherein the extrudable food composition further comprises at least one whole grain flour.

9. The process of claim 8, wherein the extrudable food composition comprises at least one of whole grain wheat flour and whole grain oat flour.

10. The process of claim 1, wherein the extrudable food composition further comprises amylase-resistant starch.

11. The process of claim 1, wherein the extrudable food composition comprises 0.1-15 wt % of octenylsuccinate starch, wherein the extrudable food composition further comprises at least one of whole grain flour and amylase-resistant starch, and wherein the extrudable food composition is heated before and/or during the extrusion of the composition through the die, whereby the composition is at least partly cooked.

12. An extrudable food composition comprising at least one of alkenylsuccinate starch and emulsifying protein, wherein the composition is capable of being extruded through a die to form an extruded food product.

13. The composition of claim 12, wherein the extrudable food composition comprises 0.01-25 wt % of alkenylsuccinate starch, emulsifying protein, or a combination of the two.

14. The composition of claim 13, wherein the extrudable food composition comprises 0.1-15 wt % of alkenylsuccinate starch, emulsifying protein, or a combination of the two.

15. The composition of claim 12, wherein the extrudable food composition comprises alkenylsuccinate starch, and wherein the alkenyl group has from 2-12 carbon atoms.

16. The composition of claim 12, wherein the extrudable food composition comprises octenylsuccinate starch.

17. The composition of claim 12, wherein the extrudable food composition comprises emulsifying wheat protein.

18. The composition of claim 12, further comprising at least one whole grain flour.

19. The composition of claim 18, wherein the extrudable food composition comprises at least one of whole grain wheat flour and whole grain oat flour.

20. The composition of claim 12, further comprising amylase-resistant starch.

21. The composition of claim 12, further comprising at least one of whole grain flour and amylase-resistant starch, wherein the extrudable food composition comprises 0.1-15 wt % of octenylsuccinate starch, and wherein the extrudable food composition is capable of being at least partly cooked during extrusion.
